(19) United States
(12) Patent Application Publication
(10) Pub. No.: US 2006/0116151 A1
(43) Pub. Date: Jun. 1, 2006

(54) Method and apparatus for management of paging resources associated with a push-to-talk communication session

(76) Inventors: Joseph R. Sullivan, Plainfield, IL (US); Ronald T. Crocker, St. Charles, IL (US); Yehezkel Halifa, Herzelia (IL); Lizi Patlajan, Haifa (IL); Fei Xiong, Arlington Heights, IL (US); John M. Harris, Chicago, IL (US); Thomas G. Hallin, Erie, CO (US)

Correspondence Address: MOTOROLA, INC., 1303 EAST ALGONQUIN ROAD, IL01/3RD, SCHAUMBURG, IL, 60196, US

(21) Appl. No.: 11/327,881

(22) Filed: Jan. 9, 2006

Related U.S. Application Data
(63) Continuation-in-part of application No. 10/759,440, filed on Jan. 16, 2004.
(60) Provisional application No. 60/731,049, filed on Oct. 28, 2005.

(51) Int. Cl. H04Q 7/20

(52) U.S. Cl. 455/519; 455/510

(57) ABSTRACT

A communication system provides for an expedited response to an invitation to a Push-to-Talk (PTT) communication session from a terminating side of the communication system when a target mobile station (MS) is not currently available to participate in a PTT communication session by responding to a PTT session invitation prior to an expiration of a second, Paging timer and after a predetermined number of expirations of a first, Tbsreq9 timer or after a predetermined number of unsuccessful requests to page the target MS. In another embodiment of the invention, the communication system may further consider the contents of a downlink buffer of a terminating side Packet Control Function in determining whether and when to respond to an invitation to a PTT communication session, utilizing a third, TpagingBackoff timer in determining when to request a page of a non-responsive target MS.

### CROSS REFERENCE TO RELATED APPLICATIONS

This application is a continuation-in-part of, and claims priority from, U.S. patent application Ser. No. 10/759,440, Attorney Docket No. CE10440R, entitled “Method and Apparatus for Facilitating a PTT Session Initiation Using an IP-based Protocol,” filed Jan. 16, 2004, and further claims priority from provisional U.S. Patent Application Ser. No. 60/731,049, Attorney Docket No. CE14574R, entitled “Method and Apparatus for Management of Paging Resources Associated with a Push-to-Talk Communication Session,” filed Oct. 28, 2005, which applications are commonly owned and incorporated herein by reference in their entirety.

### FIELD OF THE INVENTION

The present invention relates generally to cellular communication systems, and, in particular, to establishment of a Push-to-Talk (PTT) communication session in a cellular communication system.

### BACKGROUND OF THE INVENTION

It is well-known to use a Session Initiation Protocol (SIP) to establish a Push-to-Talk over Cellular (PoC) call. When a mobile station (MS) attempts to originate a PoC call with a target MS, the originating MS establishes a traffic channel with a Radio Access Network (RAN) serving the MS and conveys a SIP INVITE message to a PTT Server via a Packet Control Function (PCF) and a Packet Data Serving Node (PDSN) serving the MS. The PTT Server then server forwards the SIP INVITE to a target PCF serving the target MS via a target PDSN and further starts a timer. In response to receiving the SIP INVITE, the target PCF determines whether the target MS has a dormant packet data session. That is, an MS's packet data session is considered to be in a dormant state when a point-to-point protocol (PPP) connection has been established between the MS and a PDSN serving the MS and bearer resources between the PCF and PDSN have been allocated to the MS but no traffic channel resources are allocated to the MS.

When the target PCF determines that the target MS has a dormant packet data session, the target PCF requests that a Mobile Switching Center (MSC) serving the target MS page the target MS. The target PCF further starts a Tbsreq9 timer, typically a 1.5 second timer, and a Paging timer, typically a 60 second timer. In response to receiving the page request, the MSC pages the target MS. If the target MS responds to the page with a Page Response, a RAN serving the target MS establishes a traffic channel with the target MS. The target PCF then forwards the SIP INVITE to the target MS via the established traffic channel. In response to receiving the SIP INVITE, the target MS conveys a SIP 200 OK message to the target PCF and the PoC call is set up in coordination with the PTT Server.

When the target MS is busy or otherwise unavailable for the PoC call, the target MS may convey a busy response, or no response, to the page. The target PCF will then retry paging the target MS each time the Tbsreq9 timer expires, re-starting the timer after each paging request. After six unsuccessful pages of the target MS, the target PCF abandons use of the Tbsreq9 timer and thereafter re-requests a page of the MS upon expiration of the Paging timer, re-starting the Paging timer and re-requesting a page of the MS after each unsuccessful paging request. Meanwhile, when the target MS fails to respond to the pages prior to an expiration of the Paging timer, the target PCF does not respond to the PTT Server until the Paging timer expires, which can leave the PTT Server and originating MS waiting for a response to the SIP INVITE message for as long as a minute. In addition, so long as the pages are unsuccessful, the PTT Server repeatedly sends SIP INVITE messages to the target PCF until the PTT Server timer expires, causing SIP INVITE messages to accumulate at the target PCF.

Therefore, a need exists for a method and apparatus that, when the target MS is busy or otherwise unavailable, provides an expedited response to the originating MS and that further saves paging resources that are consumed by the repeated requests by the target PCF and PTT Server to page the target MS.

### BRIEF DESCRIPTION OF THE DRAWINGS

FIG. 1 is a block diagram of a wireless communication system in accordance with an embodiment of the present invention.

FIG. 2 is a block diagram of a packet control function of FIG. 1 in accordance with an embodiment of the present invention.

FIG. 3 is a block diagram of a mobile station of FIG. 1 in accordance with an embodiment of the present invention.

FIG. 4 is a signal flow diagram illustrating a management of paging resources by the communication system of FIG. 1 in accordance with various embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are often not depicted in order to facilitate a less obstructed view of these various embodiments of the present invention.

### DETAILED DESCRIPTION OF THE INVENTION

To address the need for a method and apparatus that, when a target mobile station (MS) is busy or otherwise unavailable, provides an expedited response to an originating MS and that further saves paging resources that are consumed by the repeated requests by a terminating side, or target, Packet Control Function (PCF) and Push-to-Talk (PTT) Server to page the target MS, a communication system is provided that provides for an expedited response to an invitation to a PTT communication session from a terminating side of the communication system when a target MS is not currently available to participate in a PTT communication session by responding to a PTT session invitation prior to an expiration of a second, Paging timer and after a predetermined number of expirations of a first, Tbsreq9 timer or after a predetermined number of unsuccessful requests to page the target MS. In another embodiment of the invention, the communication system may further consider the contents of a downlink buffer of the terminating side PCF in determining whether and when to respond to an invitation to a PTT communication session, utilizing a third, TpagingBackoff timer in determining when to request a page of a non-responsive target MS.

Generally, an embodiment of the present invention encompasses a method for managing paging resources associated with a push-to-talk communication session in a wireless communication system. The method includes receiving an invitation to a Push-to-Talk (PTT) communication session that is intended for a mobile station (MS), starting a first timer and a second timer, wherein the second timer is longer than the first timer, and requesting a page of the MS. The method further include re-starting the first timer and re-requesting a page of the MS each time the first timer expires prior to both a receipt of a response to the request and a predetermined number of expirations of the first timer and, when the first timer expires a predetermined number of times and prior to an expiration of the second timer, conveying a response to the received invitation.

Another embodiment of the present invention encompasses a method for managing paging resources associated with a push-to-talk communication session in a wireless communication system. The method includes receiving an invitation to a PTT communication session that is intended for an MS, starting a timer, and requesting a page of the MS. The method further includes re-starting the timer and re-requesting a page of the MS each time the timer expires prior to receipt of a response to the request and, in response to re-requesting a page of the mobile station a predetermined number of times without receiving a response to the request, conveying a response to the received invitation.

Yet another embodiment of the present invention encompasses a method for managing paging resources associated with a PTT communication session in a wireless communication system. The method includes receiving an invitation to a PTT communication session that is intended for an MS, starting a first timer and a second timer, requesting a page of the MS and, in response to an unsuccessful page request, conveying a response to the received invitation subsequent to the expiration of the first timer and prior to an expiration of the second timer.

Still another embodiment of the present invention encompasses a Packet Control Function (PCF) having a processor that is configured to receive an invitation to a PTT communication session that is intended for an MS, start a first timer and a second timer, wherein the second timer is longer than the first timer, request a page of the MS, re-start the first timer and re-request a page of the MS each time the first timer expires prior to both a receipt of a response to the request and a predetermined number of expirations of the first timer and, when the first timer expires a predetermined number of times and prior to an expiration of the second timer, convey a response to the received invitation.

Yet another embodiment of the present invention encompasses a PCF having a processor that is configured to receive an invitation to a PTT communication session that is intended for an MS, start a timer, request a page of the MS, re-start the timer and re-request a page of the MS each time the timer expires prior to receipt of a response to the request and, in response to re-requesting a page of the MS a predetermined number of times, conveys a response to the received invitation.

Still another embodiment of the present invention encompasses a PCF having a processor that is configured to receive an invitation to a PTT communication session that is intended for an MS, start a first timer and a second timer, request a page of the MS, and in response to an unsuccessful page request, convey a response to the received invitation subsequent to the expiration of the first timer and prior to an expiration of the second timer.

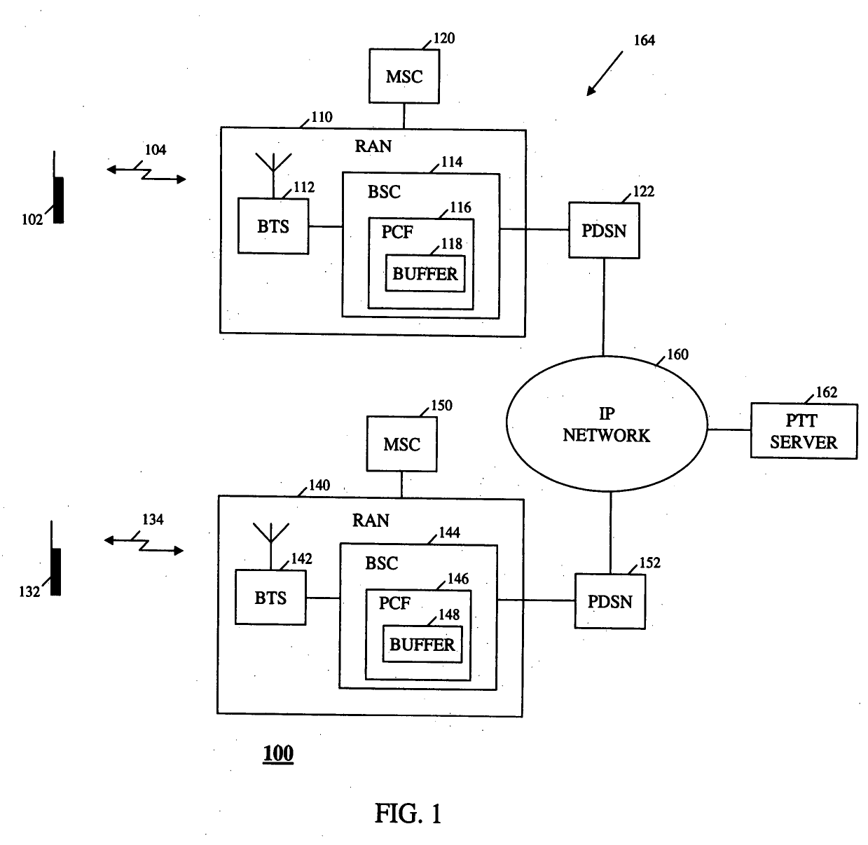

The present invention may be more fully described with reference to FIGS. 1-4. FIG. 1 is a block diagram of a wireless communication system 100 in accordance with an embodiment of the present invention. Communication system 100 includes multiple Radio Access Networks (RANs) 110, 140 (two shown) that each provides wireless communication services to mobile stations residing in a coverage area of the RAN. Each RAN of the multiple RANs 110, 140 includes a respective Base Transceiver Station (BTS) 112, 142 that is operably coupled to a respective Base Station Controller (BSC) 114, 144. Each BSC 114, 144 includes a respective Packet Control Function (PCF) 116, 146. However, in another embodiment of the present invention, each PCF 116, 146 may be external to, and in communication with, the corresponding BSC. Each PCF 116, 146 is operably coupled to a respective Packet Data Service Node (PDSN) 122, 152 and, via the PDSN and an Internet Protocol (IP) core network 160, to a respective Push-to-Talk Server 162, such as a Push-to-Talk over Cellular (PoC) Server. Together, RANs 110 and 140, MSCs 120 and 150, PDSNs 122 and 152, PTT Server 162, and IP network 160 are collectively referred to herein as a telecommunications network 164. In addition, each of BTSs 112 and 142, BSCs 114 and 144, PCFs 116 and 146, MSCs 120 and 150, PDSNs 122 and 152, and PTT Server 162 comprises an element of telecommunications network 164 and may be referred to herein as a network element.

Communication system 100 further comprises multiple PTT-enabled mobile stations (MSs) 102, 132 (two shown), such as but not limited to a cellular phone, a radiotelephone, or a wireless communication-enabled personal computer, laptop computer, or personal digital assistant (PDA). Each RAN 110, 140 provides communications services to a respective MS 102, 132 residing in a coverage area of the RAN via a respective air interface 104, 134. Each air interface 104, 134 includes a downlink that includes including at least one downlink traffic channel, at least one downlink signaling channel, and a paging channel. Each air interface 104, 134 further includes an uplink that includes at least one uplink traffic channel, at least one uplink signaling channel, and an access channel.

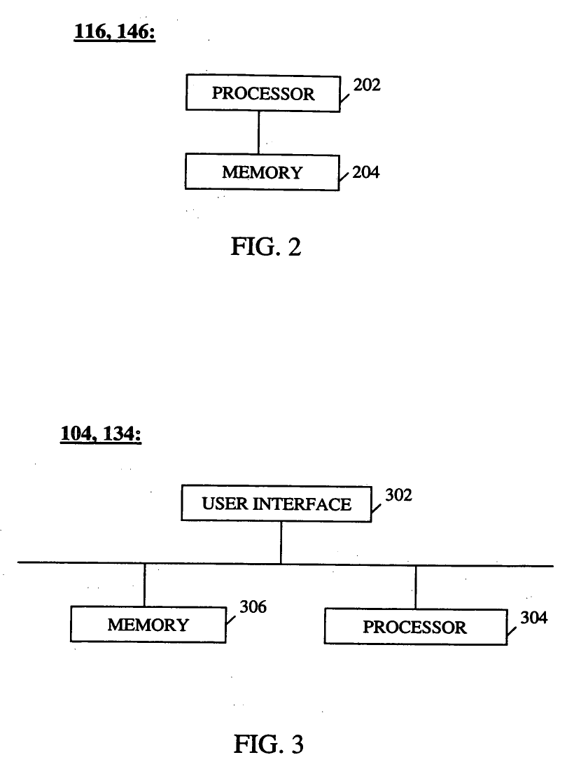

FIG. 2 is a block diagram of PCFs 116 and 146 in accordance with an embodiment of the present invention. Each PCF 116, 146 includes a processor 202, such as one or more microprocessors, microcontrollers, digital signal processors (DSPs), combinations thereof or such other devices known to those having ordinary skill in the art. Each PCF 116, 146 further includes at least one memory device 204 associated with processor 202, such as random access memory (RAM), dynamic random access memory (DRAM), and/or read only memory (ROM) or equivalents thereof, that store data and programs, such as Session Initiation Protocol (SIP)-related programs, that may be executed by the processor and that allow the PCF to perform all functions necessary to operate in communication system 100. Each PCF 116, 146 further includes a respective downlink buffer 118, 148 for storing data for transfer to one or more MSs serviced by the PCF. For example, buffer 118 may store data for transfer to MS 102 and buffer 148 may store data for transfer to MS 132. Each buffer 118, 148 may be implemented in the at least one memory device 204 associated with a corresponding PCF. When a PCF 116, 146 is implemented in a corresponding BSC 114, 144, the PCF may be implemented with or in software programs and instructions stored in an at least one memory device and executed by a processor of a corresponding BSC, in which event processor 202 comprises a processor of the BSC and at least one memory device 204 comprises an at least one memory device of the BSC.

FIG. 3 is a block diagram of MSs 104 and 134 in accordance with an embodiment of the present invention. Each MS 104, 134 includes a user interface 302 coupled to a processor 304, such as one or more microprocessors, microcontrollers, digital signal processors (DSPs), combinations thereof or such other devices known to those having ordinary skill in the art. User interface 302 provides a user of the MS with the capability of interacting with the MS, including inputting instructions into the MS. In one embodiment of the present invention, user interface 302 may include a display screen and a keypad that includes multiple keys, including a Push-to-Talk (PTT) key, that may be used by a user of the MS to input instructions into the MS. In another embodiment of the present invention, display screen may comprise a touch screen. Each MS 104, 134 further includes at least one memory device 306 associated with processor 304, such as random access memory (RAM), dynamic random access memory (DRAM), and/or read only memory (ROM) or equivalents thereof, that maintain data and programs that may be executed by the processor and that allow the MS to perform all functions necessary to operate in communication system 100.

The embodiments of the present invention preferably are implemented within each of MSs 104 and 134 and BSCs 114 and 144, and more particularly within a respective PCF 116, 146 included in BSCs 114 and 144, with or in software programs and instructions stored in the at least one memory devices and executed by the processors of the MSs and BSCs/PCFs. However, one of ordinary skill in the art realizes that the embodiments of the present invention alternatively may be implemented in hardware, for example, integrated circuits (ICs), application specific integrated circuits (ASICs), and the like, such as ASICs implemented in the MSs or BSCs/PCFs, and all references to ‘means for’ herein may refer to any such implementation of the present invention. Based on the present disclosure, one skilled in the art will be readily capable of producing and implementing such software and/or hardware without undo experimentation.

Preferably, communication system 100 is a packet switched CDMA (Code Division Multiple Access) communication system, such as a CDMA 2000 1XEV-DO (1X Evolution Data Only), a CDMA 2000 1XEV-DV (1X Evolution Data and Voice) or a packet switched CDMA 1XRTT (1X Radio Transmission Technology) communication system. To ensure compatibility, radio system parameters and call processing procedures are specified by the standards, including call processing steps that are executed by an MS and a RAN serving the MS and between the RAN and associated infrastructure in order to establish a call or execute a handoff. However, those who are of ordinary skill in the art realize that communication system 100 may operate in accordance with any one of a variety of wireless packet data communication systems capable of providing PoC services, such as but not limited to a General Packet Radio Service (GPRS) communication system, a Universal Mobile Telecommunication System (UMTS) communication system, a Wireless Local Area Network (WLAN) communication system as described by the IEEE (Institute of Electrical and Electronics Engineers) 802.xx standards, for example, the 802.11, 802.15, 802.16, or 802.20 standards, or Fourth Generation (4G) communication systems such as an Orthogonal Frequency Division Multiple Access (OFDM) communication system.

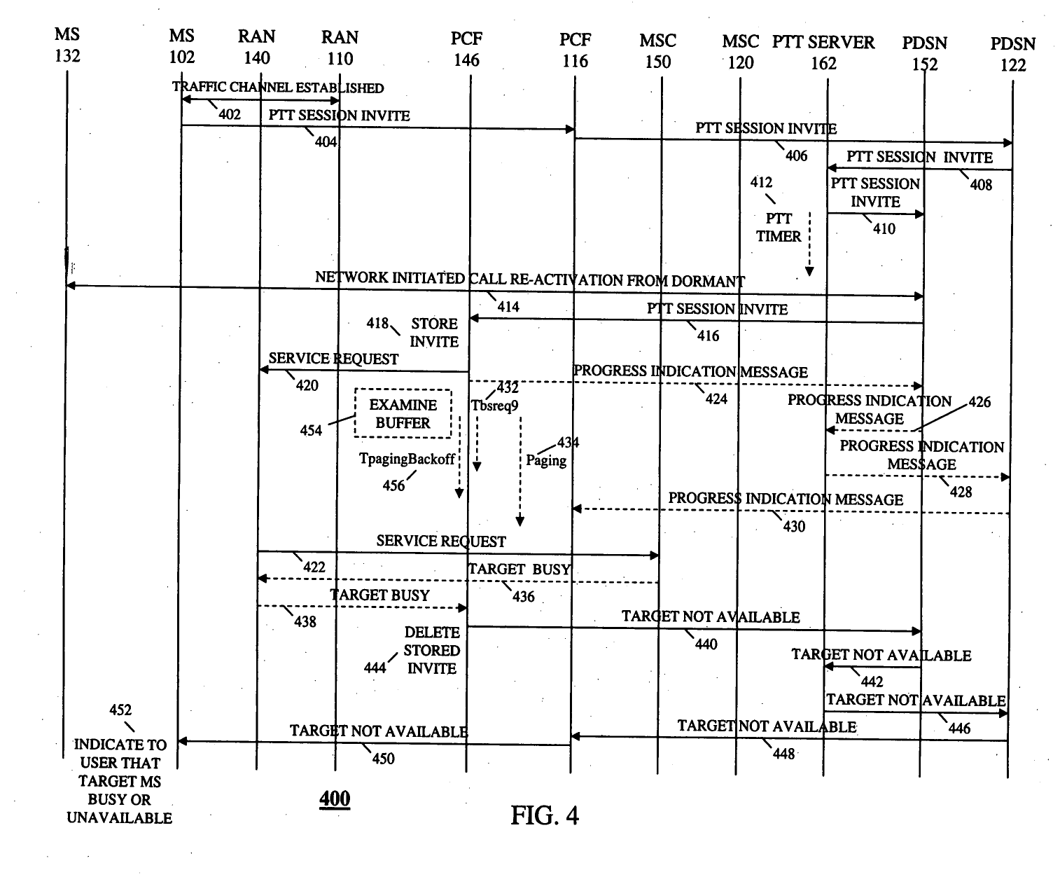

Referring now to FIG. 4, a signal flow diagram 400 is provided that illustrates a management of paging resources by communication system 100 in accordance with various embodiments of the present invention. Paging resources comprise resources of communication system 100 utilized to page an MS, such as messages exchanged among network elements and between network elements and MSs and bearer and signaling links utilized for an exchange of such messages. Signal flow diagram 400 begins when a first, originating MS, such as MS 102, initiates a Push-to-Talk (PTT) communication session. Typically, an originating MS, such as MS 102, initiates a PTT communication session by establishing (402) a traffic channel with a RAN serving the MS, that is, RAN 110, in an associated air interface, that is, air interface 104. Originating MS 102 then generates a point-to-point protocol (PPP) frame that includes an invitation, for example, a SIP (Session Initiation Protocol) INVITE message, for a second, target MS, such as MS 132, to participate in the PTT communication session. MS 102 further includes a call identifier in the PPP frame that is uniquely associated with the communication session. Originating MS 102 then conveys (404) the PPP frame to originating PCF 116 via a RAN serving the MS, that is, originating RAN 110. The PTT session invitation identifies originating MS 102 and target MS 132, for example, by including PoC Addresses associated with each of the originating MS and target MS.

In response to receiving the PPP frame, PCF 116 forwards (406) the frame and the PTT session invitation to a PDSN serving the MS, that is, originating PDSN 122. In turn, PDSN 122 forwards (408) the PPP frame and PTT session invitation to PTT Server 162. In response to receiving the PPP frame from PDSN 122, PTT Server 162 assembles, and conveys (410) to a terminating side PDSN, that is, PDSN 152, serving the target MS, that is, MS 132, a PPP frame that includes an invitation, preferably a SIP INVITE message, to target MS 132 to participate in the PTT communication session with MS 102. The PPP frame further includes the call identifier provided by MS 102. In another embodiment of the present invention, PTT Server 162 may forward to PDSN 152 the PPP frame received from PDSN 122. As used herein, references to an originating side of communication system 100 or to an originating network element refer to a side of telecommunications infrastructure 164 serving originating MS 102, that is, RAN 110, MSC 120, and PDSN 122, and references to a terminating side of communication system 100 or to a terminating network element refer to a side of telecommunications infrastructure 164 serving target MS 132, that is, RAN 140, MSC 150, and PDSN 152.

In addition to conveying the invitation to PDSN 152, PTT Server 162 further starts (412) a PTT timer included in the PTT Server. When the PTT timer expires before PTT Server 162 receives an acknowledgement of a successful page of target MS 132 from the terminating side of the system 100, the PTT Server tears down the call set up with originating MS 102 and conveys a message to terminating PCF 146 informing that the communication session is cancelled.

It is assumed that target MS 132 has a dormant packet data session at the time that MS 102 attempts to set up a PTT communication session with the target MS and a first, in time, invitation for the PTT session is received by terminating PCF 146. MS 132 has a dormant packet data session when a point-to-point protocol (PPP) connection has been established between MS 132 and terminating PDSN 152 and bearer resources between terminating PCF 146 and PDSN 152 have been allocated to the MS but no traffic channel resources (in air interface 134) are allocated to the MS. In response to receiving the data packet from PTT Server 162, terminating PDSN 152 initiates (414) a call reactivation with target MS 132, converting the MS's dormant packet data session to an activated packet data session. PDSN 152 further forwards (416) a data packet comprising the PPP frame and PTT session invitation received from PTT Server 162 to a terminating side PCF, that is, PCF 146, serving target MS 132.

In response to receiving the PPP frame from terminating PDSN 152, terminating PCF 146 stores (418) the PPP frame in the downlink buffer 148 of the PCF. Terminating PCF 146 further interrogates the frame in order to determine whether the frame includes the invitation for MS 132 to participate in the PTT communication session with MS 102. In addition, terminating PCF 146 determines whether target MS 132 has a dormant packet data session and may check the PCF's downlink buffer 148 to determine whether the buffer is maintaining any data for transfer to MS 132.

When terminating PCF 146 determines that target MS 132 has a dormant packet data session and that the PPP frame comprises an invitation for MS 132 to participate in a PTT communication session, the PCF requests (420, 422) that a terminating side MSC serving the target MS 132, that is, MSC 150, page the target MS. Preferably, terminating PCF 146 requests that MSC 150 page MS 132 by assembling, and conveying to the MSC via terminating RAN 140, a BS_Service_Request message. Terminating PCF 146 further starts (432, 434) a first, short timer, that is, a ‘Tbsreq9’ timer, included in the PCF that typically counts down a 1.5 second time period, and a second, long timer, that is, a ‘Paging’ timer, included in the PCF that typically counts down a 60 second time period.

In addition, in response to requesting a page of target MS 132, terminating PCF 146 may assemble and convey (424, 426) to PTT Server 162, via terminating PDSN 152, a PPP frame comprising a progress indication message informing that the PCF is attempting to add the target MS to the session. For example, the progress indication message may comprise any of a SIP INFO message, a SIP 100 Trying message, and a SIP 183 Session Progress message. Additionally, the progress information message may further include information that indicates an anticipated time or times at which the page(s) will be sent to target MS 132. In this way, for example, when the transmitting side of communication system 100 first receives the invite, the transmitting side, and in particular target PCF 146, can generate a response indicating the times at which the pages will go out to target MS 132. These times may be based on the wake-up times for that particular target MS, that is, times known to network 164, and in particular to RAN 140 and more particularly BSC 144 and/or PCF 146 and maintained in the at least one memory device of the BSC and/or PCF, when that mobile wakes up to check for pages. Then, PTT Server 162 may simply give up on the target MS if the PTT Server does not receive a response within some short time interval after the page was supposed to have gone out to the target MS, as the PTT Server may assume that the PTT Server should have received some sort of message indicating that the invitation to participate in the PTT communication session, that is, the SIP INVITE request, has been successfully executed, such as a SIP 200 OK message, from the terminating side of communication system 100 if the target MS had been successfully paged.

In response to receiving the progress indication message, PTT Server 162 may assemble and convey (428, 430) to originating PCF 116, via originating PDSN 122, a PPP frame comprising a progress indication message. Originating PCF 116 then forwards (not shown in FIG. 4) to originating MS 102 the PPP frame comprising the progress indication message informing that an attempt is being made to add the target MS to the session. In response receiving the message, originating MS 102 may indicate to a user of the MS that an attempt is being made to add the target MS to the session.

In response to receiving the request to page target MS 132, terminating MSC 150 determines that the MS is not currently available to participate in the PTT communication session. For example, MS 132 may be engaged in another communication session, such as a voice call, a data session, or another PTT communication session, or MS 132 may not be reachable, for example, not powered up or unreachable for any other reason, such as being out of coverage of system 100. In one embodiment of the present invention, when MSC 150 determines that target MS 132 is busy, that is, is engaged in another communication session, terminating MSC 150 may inform (436, 438) terminating PCF 146 that the target MS is busy, preferably by conveying to the PCF via RAN 140, and the PCF receiving from the MSC, a BS_Service_Response message informing that the MS is busy. In another embodiment of the present invention, when MSC 150 determines that target MS 132 is unreachable, terminating PCF 146 may not receive any response from the MSC prior to an expiration of the Tbsreq9 timer. In the latter embodiment, in response to an initial expiration of the Tbsreq9 timer, terminating PCF 146 may re-request a page of MS 132, that is, may re-convey (420, 422) the paging request to MSC 150 and re-start (432) the Tbsreq9 timer. Each time the Tbsreq9 timer expires without terminating PCF 146 receiving a response, the PCF may re-request a page of MS 132. However, after a predetermined number of expirations of the Tbsreq9 timer or a predetermined number of unsuccessful requests to page target MS 132, and prior to an expiration of the Paging timer, terminating PCF 146 may determine that the target MS is not currently available to participate in the PTT communication session. Terminating PCF 146 further may cease requesting to page the target MS.

In response to determining that target MS 132 is not currently available to participate in the PTT communication session, terminating PCF 146 informs the originating side of communication system 100 that the target MS is not currently available. Preferably, terminating PCF 146 informs PTT Server 162 of the unavailability of target MS 132 by assembling and conveying (440, 442) to the PTT Server, via terminating PDSN 152, a PPP frame comprising a message informing that target MS 132 is not currently available to participate in the PTT communication session, such as a SIP 486 BUSY HERE message. Terminating PCF 146 may further include in the PPP frame the call identifier that was included in the PPP frame received by the PCF. Terminating PCF 146 further may delete (444), from the downlink buffer 148 of the PCF, the PPP frame comprising the invitation to participate in the communication session.

In response to receiving the message informing that target MS 132 is not currently available to participate in the PTT communication, PTT Server 162 assembles and conveys (446, 448) to originating PCF 116, via originating PDSN 122, a PPP frame comprising a message informing that target MS 132 is not currently available, for example, is busy or otherwise unavailable, such as a SIP 486 BUSY HERE message. Originating PCF 116 then forwards (450) to originating MS 102 the PPP frame comprising the message in forming that the target MS is not currently available. In response receiving the message, originating MS 102 indicates (452) to a user of the MS that the target MS is not currently available. For example, originating MS 102 may play an audio signal indicating that the target MS is busy or unavailable or the originating MS may display a message on a user interface 302 of the MS informing that the target MS is busy or. Signal flow diagram 400 then ends.

Thus communication system 100 provides for an expedited response from the terminating side of system 100 when a target MS, such as MS 132, is not currently available to participate in the PTT communication session by responding to a PTT session invitation prior to an expiration of a Paging timer. In one embodiment of the present invention, in response to receiving a message from terminating MSC 150 informing that target MS 132 is busy, terminating PCF 146 may inform PTT Server 162 of a status of target MS 132 without first paging the MS, or if the MS is paged notwithstanding a busy message, then prior to a corresponding expiration of the Paging timer and without waiting for a page response from the MS. In another embodiment of the present invention, when terminating PCF 146 does not receive any response from the MSC and after a predetermined number of expirations of the Tbsreq9 timer or after a predetermined number of unsuccessful requests to page MS 132 by terminating PCF 146 (based on the Tbsreq9 timer), terminating PCF 146 may cease requesting a page of the MS based on the Tbsreq9 timer and may inform PTT Server 162 of a status of target MS 132 without waiting for an expiration of the Paging timer.

In yet another embodiment of the present invention, after the predetermined number of expirations of the Tbsreq9 timer or the predetermined number of unsuccessful requests to page MS 132, the PCF may hold off informing PTT Server 162 that target MS 132 is not currently available to participate in the PTT communication session when downlink buffer 148 maintains a non-stale invitation for the MS to participate in the session. That is, after terminating PCF 146 unsuccessfully requests to page MS 132 the first predetermined number of times based on the Tbsreq9 timer, and prior to an expiration of the Paging timer, the terminating PCF 146 may examine (454) its downlink buffer 148 to determine whether the buffer maintains data for a transfer to the MS or maintains a non-stale invitation for the same PTT communication session.

In the prior art, an invitation received by a PCF for a busy or unavailable MS is maintained in a downlink buffer of the PCF until the MS is successfully paged. While the invitation is maintained in the buffer, the PCF may receive additional invitations from the PTT Server for the same communication session and/or a cancel message from the PTT Server canceling the call. A stored invitation becomes stale when a second such invitation is received by the PCF from the PTT Server or when a message canceling the call is received by the PCF from the PTT Server. A non-stale invitation comprises an invitation that is still being acted upon by the PCF, such as an invitation in regard to which no subsequent invitation or cancel message has been received.

When downlink buffer 148 of terminating PCF 146 does not include a non-stale invitation, then the terminating PCF may assemble and convey (440, 442), to PTT Server 162, the PPP frame comprising a message informing that target MS 132 is not currently available to participate in the PTT communication session. When downlink buffer 148 includes a non-stale invitation, then terminating PCF 146 further may start (456) a third timer, that is, a ‘TpagingBackoff’ timer, that is longer than the Tbsreq9 timer. Terminating PCF 146 then begins one or more cycles of requesting a page of MS 132 based on the TpagingBackoff timer. By using the TpagingBackoff timer, a non-responsive target MS 132 is paged less frequently relative to the frequency of paging attempts based on the Tbsreq9 timer, thereby conserving paging resources.

That is, in response to the first predetermined number of unsuccessful requests by terminating PCF 146 to page MS 132 based on the Tbsreq9 timer, the terminating PCF may convey another request (420, 422) to MSC 150 to page the MS and further start (456) the TpagingBackoff timer. When terminating PCF 146 receives a paging request response from terminating MSC 150 informing that the target MS is busy, or the PCF does not receive any response from the MSC prior to an expiration of the third, ‘TpagingBackoff,’ timer, terminating PCF 146 may re-convey (420, 422) the paging request to MSC 150 and re-start (456) the TpagingBackoff timer. After a second predetermined number of unsuccessful requests to page target MS 132 prior to an expiration of the TpagingBackoff timer, terminating PCF 146 may cease further requesting a page of the target MS based upon the TpagingBackoff timer and assemble and convey (440, 442), to the PTT Server, the PPP frame comprising a message informing that target MS 132 is not currently available to participate in the PTT communication session.

In still another embodiment of the present invention, when the terminating PCF 146 examines (454) its downlink buffer 148 and determines that the buffer is empty of data for transfer to MS 132 and/or does not include a non-stale invitation for MS 132, then the PCF further may stop the Paging timer and may convert the activated packet data session with MS 132 to a dormant packet data session, thereby ceasing further re-attempts to page target MS 132 based upon the Paging timer.

Thus, in addition to providing for an expedited response from the terminating side of system 100 when a target MS is not currently available to participate in the PTT communication session by responding to a PTT session invitation prior to an expiration of a Paging timer, communication system 100 may further consider the contents of a downlink buffer of a terminating side PCF in determining whether and when to respond to an invitation to a PTT communication session. When the downlink buffer does not include a non-stale invitation, then the terminating PCF may respond to the invitation by conveying a message informing that the target MS is not currently available to participate in the PTT communication session. When downlink buffer 148 includes a non-stale invitation, then the terminating PCF may increase the time interval between each request to page the target MS by requesting a page of the target MS upon each expiration of a ‘TpagingBackoff’ timer instead of upon each expiration of the shorter ‘Tbsreq9’ timer. By using the ‘TpagingBackoff’ timer, a non-responsive target MS is paged less frequently relative to the frequency of paging attempts based on the Tbsreq9 timer, thereby conserving paging resources.

While the present invention has been particularly shown and described with reference to particular embodiments thereof, it will be understood by those skilled in the art that various changes may be made and equivalents substituted for elements thereof without departing from the scope of the invention as set forth in the claims below. Accordingly, the specification and figures are to be regarded in an illustrative rather then a restrictive sense, and all such changes and substitutions are intended to be included within the scope of the present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any variation thereof, are intended to cover a non-exclusive inclusion, such that a process, method, article, or apparatus that comprises a list of elements does not include only those elements but may include other elements not expressly listed or inherent to such process, method, article, or apparatus. It is further understood that the use of relational terms, if any, such as first and second, top and bottom, and the like are used solely to distinguish one entity or action from another entity or action without necessarily requiring or implying any actual such relationship or order between such entities or actions.

What is claimed is:

1. A method for managing paging resources associated with a push-to-talk communication session in a wireless communication system comprising:
receiving an invitation to a Push-to-Talk (PTT) communication session that is intended for a mobile station;
requesting a page of the mobile station;
starting a first timer and a second timer, wherein the second timer is longer than the first timer;
re-starting the first timer and re-requesting a page of the mobile station each time the first timer expires prior to both a receipt of a response to the request and a predetermined number of expirations of the first timer; and
when the first timer expires a predetermined number of times and prior to an expiration of the second timer, conveying a response to the received invitation.

2. The method of claim 1, wherein the response comprises a second response and wherein the method further comprises, in response to requesting a page of the mobile station, conveying a first response to the received invitation that comprises a progress indication message.

3. The method of claim 2, wherein the progress indication message comprises a message from the group consisting of a SIP INFO message, a SIP 100 Trying message, and a SIP 183 Session Progress message.

4. The method of claim 3, wherein the progress indication message comprises information that indicates an anticipated time or times at which one or more pages will be sent to the mobile station.

5. The method of claim 1, wherein the first timer is a ‘Tbsreq9’ timer and the second timer is a ‘Paging’ timer.

6. The method of claim 1, wherein receiving comprises receiving, by a Packet Control Function (PCF), an invitation conveyed by a Push-to-Talk (PTT) Server and wherein conveying a response comprises conveying, by the PCF to the PTT Server, a response to the invitation.

7. The method of claim 1, wherein the invitation comprises a SIP INVITE message.

8. The method of claim 1, wherein responding comprises conveying a SIP 486 BUSY HERE message.

9. The method of claim 1, further comprising, when the first timer expires a predetermined number of times, ceasing requesting a page of the mobile station.

10. A method for managing paging resources associated with a push-to-talk communication session in a wireless communication system comprising:
receiving an invitation to a Push-to-Talk (PTT) communication session that is intended for a mobile station;
requesting a page of the mobile station;
starting a timer;
re-starting the timer and re-requesting a page of the mobile station each time the timer expires prior to receipt of a response to the request; and
in response to re-requesting a page of the mobile station a predetermined number of times without receiving a response to the request, conveying a response to the received invitation.

11. The method of claim 10, wherein the response comprises a second response and wherein the method further comprises, in response to requesting a page of the mobile station, conveying a first response to the received invitation that comprises a progress indication message.

12. The method of claim 11, wherein the progress indication message comprises a message from the group consisting of a SIP INFO message, a SIP 100 Trying message, and a SIP 183 Session Progress message.

13. The method of claim 11, wherein the progress indication message comprises information that indicates an anticipated time or times at which one or more pages will be sent to the mobile station.

14. The method of claim 10, wherein the timer comprises a first timer and wherein the method further comprises:
starting a second timer; and
wherein the first timer is re-started and a page of the mobile station is re-requested each time the first timer expires prior to both a receipt of a response to the request and an expiration of the second timer, and wherein conveying a response to the received invitation comprises conveying a response to the received invitation prior to an expiration of the second timer.

15. The method of claim 14, wherein the first timer is a ‘Tbsreq9’ timer and the second timer is a ‘Paging’ timer.

16. The method of claim 10, further comprising, in response to re-requesting a page of the mobile station a predetermined number of times, ceasing requesting a page of the mobile station.

17. A method for managing paging resources associated with a push-to-talk (PTT) communication session in a wireless communication system comprising:
receiving an invitation to a PTT communication session that is intended for a mobile station;
requesting a page of the mobile station;
starting a first timer and a second timer; and
in response to an unsuccessful page request, conveying a response to the received invitation subsequent to the expiration of the first timer and prior to an expiration of the second timer.

18. The method of claim 17, wherein the response comprises a second response and wherein the method further comprises, in response to requesting a page of the mobile station, conveying a first response to the received invitation that comprises a progress indication message.

19. The method of claim 18, wherein the progress indication message comprises a message from the group consisting of a SIP INFO message, a SIP 100 Trying message, and a SIP 183 Session Progress message.

20. The method of claim 18, wherein the progress indication message comprises information that indicates an anticipated time or times at which one or more pages will be sent to the mobile station.

21. The method of claim 17, wherein the first timer is a ‘Tbsreq9’ timer and the second timer is a ‘Paging’ timer.

22. The method of claim 17, wherein the first timer is of a shorter duration than the second timer.

23. The method of claim 17, wherein receiving comprises receiving an invitation to a Push-to-Talk (PTT) communication session from a Push-to-Talk (PTT) Server and wherein responding comprises conveying a response to the PTT Server informing that the mobile station is not currently available to participate in the PTT communication session.

24. The method of claim 17, wherein the invitation comprises a SIP INVITE message.

25. The method of claim 17, wherein the method further comprises:
determining, by a network element, whether the network element maintains a non-stale invitation for the same Push-to-Talk (PTT) communication session;
in response to a first predetermined number of unsuccessful page requests and further in response to determining that the network element maintains a non-stale invitation for the same PTT communication session, re-requesting a page of the mobile station; and
starting a third timer.

26. The method of claim 25, wherein starting a third timer comprises starting a ‘TpagingBackoff’ timer.

27. The method of claim 25, further comprising:
requesting a page of the mobile station one or more times based on the third timer; and
in response to a second predetermined number of unsuccessful page attempts based on the third timer, conveying a response to the received invitation.

28. The method of claim 17, further comprising:
determining whether data is being maintained data for transfer to the mobile station; and
in response to determining that no data is being maintained data for transfer to the mobile station, stopping the second timer.

29. The method of claim 17, further comprising:
in response to receiving the invitation to a Push-to-Talk (PTT) communication session, activating a dormant packet data session of the mobile station;
determining whether data is being maintained data for transfer to the mobile station; and
in response to determining that no data is being maintained data for transfer to the mobile station, converting the activated packet data session of the mobile station to a dormant packet data session.

30. A Packet Control Function comprising a processor that is configured to receive an invitation to a Push-to-Talk (PTT) communication session that is intended for a mobile station, request a page of the mobile station, start a first timer and a second timer, wherein the second timer is longer than the first timer, re-start the first timer and re-request a page of the mobile station each time the first timer expires prior to both a receipt of a response to the request and a predetermined number of expirations of the first timer and, when the first timer expires a predetermined number of times and prior to an expiration of the second timer, convey a response to the received invitation.

31. The Packet Control Function of claim 30, wherein the response comprises a second response to the received invitation and wherein the processor, in response to requesting a page of the mobile station, conveys a first response to the received invitation that comprises a progress indication message.

32. The Packet Control Function of claim 31, wherein the progress indication message comprises a message from the group consisting of a SIP INFO message, a SIP 100 Trying message, and a SIP 183 Session Progress message.

33. The Packet Control Function of claim 31, wherein the progress indication message comprises information that indicates an anticipated time or times at which one or more pages will be sent to the mobile station.

34. The Packet Control Function of claim 30, wherein the first timer is a ‘Tbsreq9’ timer and the second timer is a ‘Paging’ timer.

35. The Packet Control Function of claim 30, wherein the processor receives an invitation conveyed by a Push-to-Talk (PTT) Server and wherein the processor conveys the response to the invitation to the PTT Server.

36. The Packet Control Function of claim 30, wherein the invitation comprises a SIP INVITE message.

37. The Packet Control Function of claim 30, wherein the response comprises a SIP 486 BUSY HERE message.

38. The Packet Control Function of claim 30, wherein when the first timer expires a predetermined number of times, the processor ceases requesting a page of the mobile station.

39. A Packet Control Function comprising a processor that is configured to receive an invitation to a Push-to-Talk (PTT) communication session that is intended for a mobile station, request a page of the mobile station, start a timer, re-start the timer and re-request a page of the mobile station each time the timer expires prior to receipt of a response to the request and, in response to re-requesting a page of the mobile station a predetermined number of times, conveys a response to the received invitation.

40. The Packet Control Function of claim 39, wherein the response comprises a second response to the received invitation and wherein the processor, in response to requesting a page of the mobile station, conveys a first response to the received invitation that comprises a progress indication message.

41. The Packet Control Function of claim 40, wherein the progress indication message comprises a message from the group consisting of a SIP INFO message, a SIP 100 Trying message, and a SIP 183 Session Progress message.

42. The Packet Control Function of claim 40, wherein the progress indication message comprises information that indicates an anticipated time or times at which one or more pages will be sent to the mobile station.

43. The Packet Control Function of claim 39, wherein the timer comprises a first timer, wherein the processor further starts a second timer, wherein the processor re-starts the first timer and re-requests a page of the mobile station each time the first timer expires prior to both a receipt of a response to the request and an expiration of the second timer, and wherein the processor conveys a response to the received invitation prior to an expiration of the second timer.

44. The Packet Control Function of claim 43, wherein the first timer is a ‘Tbsreq9’ timer and the second timer is a ‘Paging’ timer.

45. The Packet Control Function of claim 39, wherein, in response to re-requesting a page of the mobile station a predertermined number of times, the processor ceases requesting a page of the mobile station.

46. A Packet Control Function comprising a processor that is configured to receive an invitation to a Push-to-Talk (PTT) communication session that is intended for a mobile station, request a page of the mobile station, start a first timer and a second timer, and in response to an unsuccessful page request, convey a response to the received invitation subsequent to the expiration of the first timer and prior to an expiration of the second timer.

47. The Packet Control Function of claim 46, wherein the response comprises a second response to the received invitation and wherein the processor, in response to requesting a page of the mobile station, conveys a first response to the received invitation that comprises a progress indication message.

48. The Packet Control Function of claim 47, wherein the progress indication message comprises a message from the group consisting of a SIP INFO message, a SIP 100 Trying message, and a SIP 183 Session Progress message.

49. The Packet Control Function of claim 47, wherein the progress indication message comprises information that indicates an anticipated time or times at which one or more pages will be sent to the mobile station.

50. The Packet Control Function of claim of claim 46, wherein the first timer is a ‘Tbsreq9’ timer and the second timer is a ‘Paging’ timer.

51. The Packet Control Function of claim of claim 46, wherein the first timer is of a shorter duration than the second timer.

52. The Packet Control Function of claim 46, wherein invitation to a Push-to-Talk (PTT) communication session received by the processor is conveyed by a Push-to-Talk (PTT) Server and wherein the processor responds by conveying a response to the PTT Server informing that the mobile station is not currently available to participate in the PTT communication session.

53. The Packet Control Function of claim 46, wherein the invitation comprises a SIP INVITE message.

54. The Packet Control Function (PCF) of claim 46, wherein the processor is further configured to determine whether the PCF maintains a non-stale invitation for the same Push-to-Talk (PTT) communication session, in response to a first predetermined number of unsuccessful page attempts and further in response to determining that the PCF maintains a non-stale invitation for the same PTT communication session, re-attempt a page of the mobile station, and start a third timer.

55. The Packet Control Function of claim 54, wherein the third timer comprises a ‘TpagingBackoff’ timer.

56. The Packet Control Function of claim 54, wherein the processor is further configured to attempt to page the mobile station one or more times based on the third timer and in response to a second predetermined number of unsuccessful page attempts based on the third timer, convey a response to the received invitation.

57. The Packet Control Function of claim 46, wherein the processor is further configured to determine whether data is being maintained data for transfer to the mobile station and in response to determining that no data is being maintained data for transfer to the mobile station, stop the second timer.

58. The Packet Control Function of claim 46, wherein the processor is further configured to, in response to determining that no data is being maintained data for transfer to the mobile station, converting an activated packet data session of the mobile station to a dormant packet data session.
